(19) United States
(12) Patent Application Publication
(10) Pub. No.: US 2026/0126748 A1
(43) Pub. Date: May 7, 2026

(54) SHEET CONVEYANCE DEVICE AND IMAGE FORMING APPARATUS

(71) Applicant: KYOCERA Document Solutions Inc., Osaka (JP)

(72) Inventor: Masayuki KAKUTA, Osaka (JP)

(73) Assignee: KYOCERA Document Solutions Inc., Osaka (JP)

(21) Appl. No.: 19/377,236

(22) Filed: Nov. 3, 2025

(30) Foreign Application Priority Data
Nov. 7, 2024 (JP) 2024-195135

(51) Int. Cl. G03G 15/00

(52) U.S. Cl. CPC G03G 15/6564; G03G 2215/00679

(57) ABSTRACT

A sheet conveyance device includes a conveyance roller pair formed with a first roller and a second roller. The first roller includes a first conveyance unit that includes a first roll shaft to which a first roll portion is fixed. The first conveyance unit includes a pair of bearing portions and a pair of first biasing members. The pair of bearing portions rotatably support both end portions of the first roll shaft in a sheet width direction, and are movable together with the first roll shaft in the sheet width direction. The pair of first biasing members bias the pair of bearing portions in opposite directions along the sheet width direction.

### INCORPORATION BY REFERENCE

This application is based upon and claims the benefit of priority from the corresponding Japanese Patent Application No. 2024-195135 filed on November 7, 2024, the entire contents of which are incorporated herein by reference.

### BACKGROUND

The present disclosure relates to a sheet conveyance device and an image forming apparatus.

An image forming apparatus such as a copying machine or a printer includes a sheet conveyance device. The sheet conveyance device includes a conveyance roller pair which conveys a sheet. The sheet conveyance device conveys sheets one by one from a sheet supply unit which stacks and stores the sheets serving as recording media used for printing (recording) images toward an image formation unit (transfer unit), a fixing unit and a sheet ejection unit. A technique is known which corrects a displacement in the position of the sheet which is conveyed.

### SUMMARY

A sheet conveyance device according to an aspect of the present disclosure includes a registration roller pair and a conveyance roller pair. The registration roller pair extends in a sheet width direction orthogonal to a sheet conveyance direction, and corrects a displacement in a position of a sheet being conveyed in the sheet width direction. The conveyance roller pair includes a first roller and a second roller that are arranged on an upstream side of the registration roller pair in the sheet conveyance direction and are rotatably arranged opposite each other to convey the sheet. The first roller includes a drive shaft, a first conveyance unit and a joint portion. The drive shaft extends in the sheet width direction, and a rotational drive force is transmitted to the drive shaft. The first conveyance unit includes a first roll shaft which is arranged side by side with the drive shaft in the sheet width direction, and to which a first roll portion that makes contact with the second roller is fixed. The joint portion couples the drive shaft to the first roll shaft in the sheet width direction, and holds the first roll shaft such that the first roll shaft is movable in the sheet width direction. The first conveyance unit includes a pair of bearing portions and a pair of first biasing members. The pair of bearing portions rotatably support both end portions of the first roll shaft in the sheet width direction respectively, and are movable along the sheet width direction together with the first roll shaft. The pair of first biasing members respectively bias the pair of bearing portions in opposite directions along the sheet width direction.

### BRIEF DESCRIPTION OF THE DRAWINGS

FIG. 1 is a schematic cross-sectional front view of an image forming apparatus according to an embodiment of the present disclosure;

FIG. 2 is a cross-sectional front view of a sheet conveyance device in the image forming apparatus shown in FIG. 1;

FIG. 3 is a front view of an area around a conveyance roller pair in the sheet conveyance device shown in FIG. 2;

FIG. 4 is a side view of a first roller in the conveyance roller pair shown in FIG. 3;

FIG. 5 is a cross-sectional side view of the joint portion of the first roller shown in FIG. 4;

FIG. 6 is a cross-sectional side view of an area around a bearing portion for a first roll shaft in the first roller shown in FIG. 4; and

FIG. 7 is a side view of a second roller in the conveyance roller pair shown in FIG. 3.

### DETAILED DESCRIPTION

An embodiment of the present disclosure will be described below with reference to drawings. The present disclosure is not limited to details which will be described below.

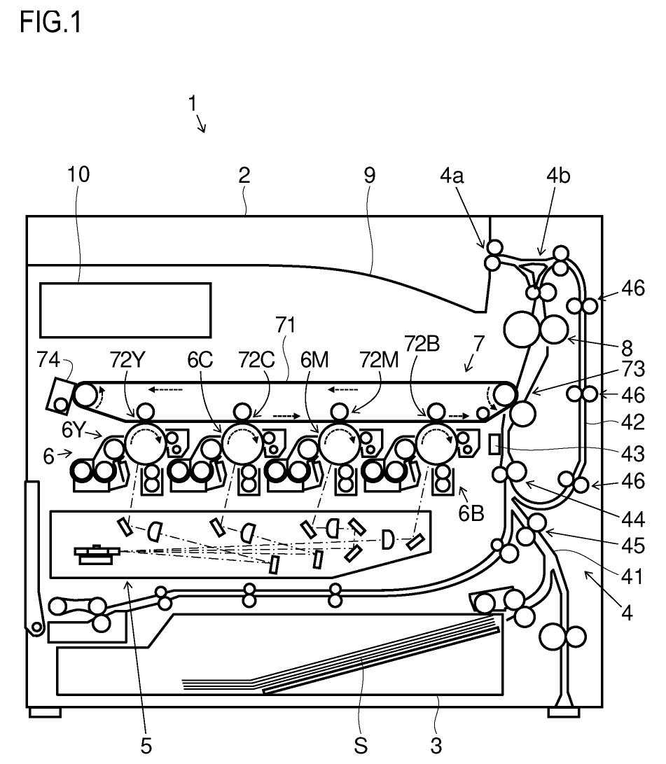

FIG. 1 is a schematic cross-sectional front view of an image forming apparatus 1 according the embodiment. An example of the image forming apparatus 1 in the present embodiment is a color printer of a tandem system which uses an intermediate transfer belt 71 to transfer a toner image to a sheet S. The image forming apparatus 1 may be, for example, a so-called multifunctional peripheral which has the functions of printing, scanning (image reading), facsimile transmission and the like.

As shown in FIG. 1, the image forming apparatus 1 includes a sheet supply unit 3, a sheet conveyance device 4, an exposure unit 5, image formation units 6, a transfer unit 7, a fixing unit 8, a sheet ejection unit 9 and a control unit 10 which are provided in an apparatus main body 2.

The sheet supply unit 3 is arranged in a bottom portion of the apparatus main body 2. The sheet supply unit 3 stores a plurality of sheets S before printing, and separates and feeds the sheets S one by one during the printing. The sheet conveyance device 4 extends in an up/down direction along a side wall of the apparatus main body 2. The sheet conveyance device 4 conveys the sheet S fed from the sheet supply unit 3 to a secondary transfer unit 73 and the fixing unit 8, and further ejects the sheet S after fixing from a sheet ejection port 4a to the sheet ejection unit 9. When double-sided printing is performed, the sheet conveyance device 4 distributes, with a branch portion 4b, the sheet S with a first surface fixed to a reverse conveyance path 42, and conveys the sheet S again to the secondary transfer unit 73 and the fixing unit 8. The exposure unit 5 is arranged above the sheet supply unit 3. The exposure unit 5 applies laser light controlled based on image data toward the image formation units 6.

The image formation units 6 are arranged above the exposure unit 5 and below the intermediate transfer belt 71. The image formation units 6 include an image formation unit 6Y for yellow, an image formation unit 6C for cyan, an image formation unit 6M for magenta and an image formation unit 6B for black. These four image formation units 6 have the same basic configuration. Hence, in the following description, unless otherwise specified, identification symbols “Y”, “C”, “M” and “B” representing the colors may be omitted.

Each of the image formation units 6 includes a photosensitive drum which is supported to be rotatable in a predetermined direction (clockwise in FIG. 1). The image formation unit 6 further includes, around the photosensitive drum, a charging unit, a development unit and a drum cleaning unit which are arranged along the direction of rotation thereof. A primary transfer unit 72 is arranged between the development unit and the drum cleaning unit.

The photosensitive drum is formed in the shape of a cylinder which extends in a horizontal direction, and includes a photosensitive layer on an outer circumferential surface. The charging unit charges the outer circumferential surface of the photosensitive drum to a predetermined surface potential. The exposure unit 5 exposes the outer circumferential surface of the photosensitive drum charged by the charging unit, and thereby forms, on the outer circumferential surface of the photosensitive drum, an electrostatic latent image of a document image with the charging attenuated. The development unit supplies a toner to the electrostatic latent image on the outer circumferential surface of the photosensitive drum, and develops the electrostatic latent image to form a toner image. The four image formation units 6 form toner images of different colors. The drum cleaning unit performs cleaning by removing the toner and the like left on the outer circumferential surface of the photosensitive drum after the toner image is primarily transferred to the outer circumferential surface of the intermediate transfer belt 71. In this way, the image formation units 6 form the images (toner images) which will be transferred to the sheet S later.

The transfer unit 7 includes the intermediate transfer belt 71, primary transfer units 72Y, 72C, 72M and 72B, the secondary transfer unit 73 and a belt cleaning unit 74. The intermediate transfer belt 71 is arranged above the four image formation units 6. The intermediate transfer belt 71 is an endless intermediate transfer member which is supported to be rotatable in a predetermined direction (counterclockwise in FIG. 1), and to which the toner images formed in the four image formation units 6 are primarily transferred to be stacked in a sequential manner. The four image formation units 6 are arranged as a so-called tandem system in which the image formation units 6 are aligned from an upstream side to a downstream side in the direction of rotation of the intermediate transfer belt 71.

The primary transfer units 72Y, 72C, 72M and 72B are arranged above the image formation units 6Y, 6C, 6M and 6B of the colors through the intermediate transfer belt 71. The secondary transfer unit 73 is arranged on an upstream side with respect to the fixing unit 8 in the sheet conveyance direction of the sheet conveyance device 4 and on a downstream side with respect to the four image formation units 6Y, 6C, 6M and 6B in the direction of rotation of the intermediate transfer belt 71. The belt cleaning unit 74 is arranged on the downstream side with respect to the secondary transfer unit 73 in the direction of rotation of the intermediate transfer belt 71.

The primary transfer units 72 transfer the toner images formed on the outer circumferential surfaces of the photosensitive drums to the intermediate transfer belt 71. In other words, the toner images are primarily transferred to the outer circumferential surface of the intermediate transfer belt 71 in the primary transfer units 72Y, 72C, 72M and 72B of the colors. Then, as the intermediate transfer belt 71 is rotated, the toner images of the four image formation units 6 are continuously transferred to the intermediate transfer belt 71 to be stacked at a predetermined timing, with the result that a color toner image obtained by superimposing the toner images of the four colors of yellow, cyan, magenta and black is formed on the outer circumferential surface of the intermediate transfer belt 71.

The color toner image on the outer circumferential surface of the intermediate transfer belt 71 is transferred, at a secondary transfer nip portion formed in the secondary transfer unit 73, to the sheet S fed in synchronization by the sheet conveyance device 4. The belt cleaning unit 74 performs cleaning by removing substances such as the toners left and adhered on the outer circumferential surface of the intermediate transfer belt 71 after secondary transfer. In this way, the transfer unit 7 transfers (records) the toner images formed on the outer circumferential surfaces of the photosensitive drums to the sheet S.

The fixing unit 8 is arranged on the downstream side of the secondary transfer unit 73 in the sheet conveyance direction and above the secondary transfer unit 73. The fixing unit 8 heats and pressurizes the sheet S to which the toner images have been transferred, and thereby fixes the toner images to the sheet S.

The sheet ejection unit 9 is arranged on the downstream side of the fixing unit 8 in the sheet conveyance direction and in the upper surface of the apparatus main body 2. The sheet S to which the toner images have been fixed and in which printing has been completed is passed through the sheet ejection port 4a, and is conveyed to the sheet ejection unit 9. In the sheet ejection unit 9, the sheet (printed product) after the printing is take out from above.

The control unit 10 includes a CPU, an image processing unit, a storage unit and other electronic circuits and electronic components (all of which are not shown). The CPU controls, based on control programs and data stored in the storage unit, the operations of constituent elements provided in the image forming apparatus 1, and thereby performs processing related to the functions of the image forming apparatus 1. The sheet supply unit 3, the sheet conveyance device 4, the exposure unit 5, the image formation units 6, the transfer unit 7 and the fixing unit 8 individually receive commands from the control unit 10 to perform the printing on the sheet S in conjunction with each other. The storage unit is formed with, for example, a combination of nonvolatile storage devices (not shown) such as a program ROM (Read Only Memory) and a data ROM and volatile storage devices (not shown) such as a RAM (Random Access Memory).

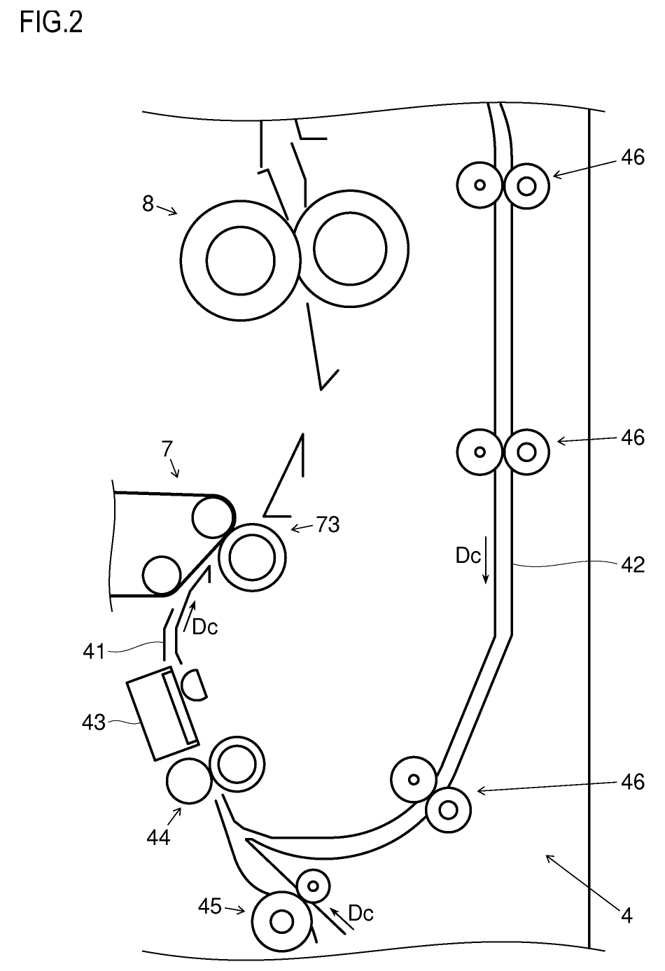

The configuration of the sheet conveyance device 4 will then be described. FIG. 2 is a cross-sectional front view of the sheet conveyance device 4 in the image forming apparatus 1 shown in FIG. 1. In FIG. 2, constituent elements other than main portions related to the detailed description are omitted.

As shown in FIG. 2, the sheet conveyance device 4 includes a sheet conveyance path 41, the reverse conveyance path 42, a sheet detection unit 43, a registration roller pair 44, conveyance roller pairs 45 and conveyance roller pairs 46.

The sheet conveyance path 41 extends from the downstream side of the sheet supply unit 3 in the sheet conveyance direction via the secondary transfer unit 73 and the fixing unit 8 to the upstream side of the sheet ejection unit 9 in the sheet conveyance direction substantially in the up/down direction. At the downstream end of the sheet conveyance path 41 in the sheet conveyance direction, the sheet ejection port 4a arranged opposite the sheet ejection unit 9 is provided. Between the fixing unit 8 and the sheet ejection port 4a in the sheet conveyance path 41, a branch portion 4b at which the reverse conveyance path 42 branches is provided.

In the sheet conveyance path 41, a plurality of conveyance roller pairs 45 including the registration roller pair 44 are provided. Each of the conveyance roller pairs 45 extends in a sheet width direction (depth direction in the plane of the sheet in FIG. 2) orthogonal to the sheet conveyance direction of the sheet conveyance path 41. The sheet conveyance path 41 conveys, with the conveyance roller pairs 45, the sheet S fed from the sheet supply unit 3 to the secondary transfer unit 73 and the fixing unit 8, and further ejects the sheet S after the fixing from the sheet ejection port 4a to the sheet ejection unit 9.

The reverse conveyance path 42 is closely adjacent to the side wall of the apparatus main body 2 as compared with the sheet conveyance path 41, and extends immediately inside the side wall in the up/down direction. The reverse conveyance path 42 branches from the sheet conveyance path 41 at the branch portion 4b, extends in a downward direction and merges with the sheet conveyance path 41 below the registration roller pair 44, that is, on the downstream side in the sheet conveyance direction.

In the reverse conveyance path 42, a plurality of conveyance roller pairs 46 are provided. Each of the conveyance roller pairs 46 extends in the sheet width direction of the reverse conveyance path 42. The reverse conveyance path 42 conveys, with the conveyance roller pairs 46, the sheet S distributed to the reverse conveyance path 42 at the branch portion 4b downward along the side wall of the apparatus main body 2, and feeds the sheet S to the sheet conveyance path 41 below the registration roller pair 44, that is, on the downstream side in the sheet conveyance direction.

In a part where the sheet conveyance path 41 and the reverse conveyance path 42 are arranged, an opening/closing unit (not shown) is provided. The opening/closing unit extends along the side wall of the apparatus main body 2 in the up/down direction. The opening/closing unit is supported to the apparatus main body 2 to be swingable around a rotation shaft arranged at a lower end portion and extending along the forward/backward direction (depth direction in the plane of the sheet in FIGS. 1 and 2) of the apparatus main body 2 with an upper end portion serving as a free end. The upper end portion is tilted to a side (right side in FIGS. 1 and 2) to separate from the apparatus main body 2, and thus the opening/closing unit can expose the sheet conveyance path 41 including an area around the registration roller pair 44. In other words, the opening/closing unit is attached to the apparatus main body 2 such that the opening/closing unit can be opened and closed with respect to the apparatus main body 2.

The sheet detection unit 43 is arranged, on the sheet conveyance path 41, on the upstream side of the secondary transfer unit 73 and on the downstream side of the registration roller pair 44 (below the secondary transfer unit 73 and above the registration roller pair 44 in FIG. 2) in the sheet conveyance direction. The sheet detection unit 43 includes, for example, a contact image sensor (CIS). The contact image sensor extends over the entire sheet conveyance path 41 in the sheet width direction.

The contact image sensor emits light from a light source incorporated toward the sheet conveyance path 41, receives the reflected light thereof and thereby detects, based on a difference in light intensity between a part where the light is blocked by the sheet S and a part where the light is not blocked, an end portion of the sheet S in the sheet conveyance direction (up/down direction in FIG. 2) and an end portion in the sheet width direction (depth direction in the plane of the sheet in FIG. 2). In this way, the sheet detection unit 43 detects the amount of displacement in the position of the sheet S conveyed on the sheet conveyance path 41 in the sheet width direction.

The registration roller pair 44 is arranged on the upstream side of the sheet detection unit 43 in the sheet conveyance direction. The sheet S fed from the sheet supply unit 3 and the sheet S conveyed along the reverse conveyance path 42 reach the location of the registration roller pair 44. The control unit 10 uses the registration roller pair 44 to correct a displacement in the position of the sheet S in the sheet width direction, to adjust the timing of the toner image formation performed by the image formation units 6 and the primary transfer performed by the transfer unit 7 and the conveyance of the sheet S and to feed the sheet S toward the secondary transfer nip portion of the secondary transfer unit 73.

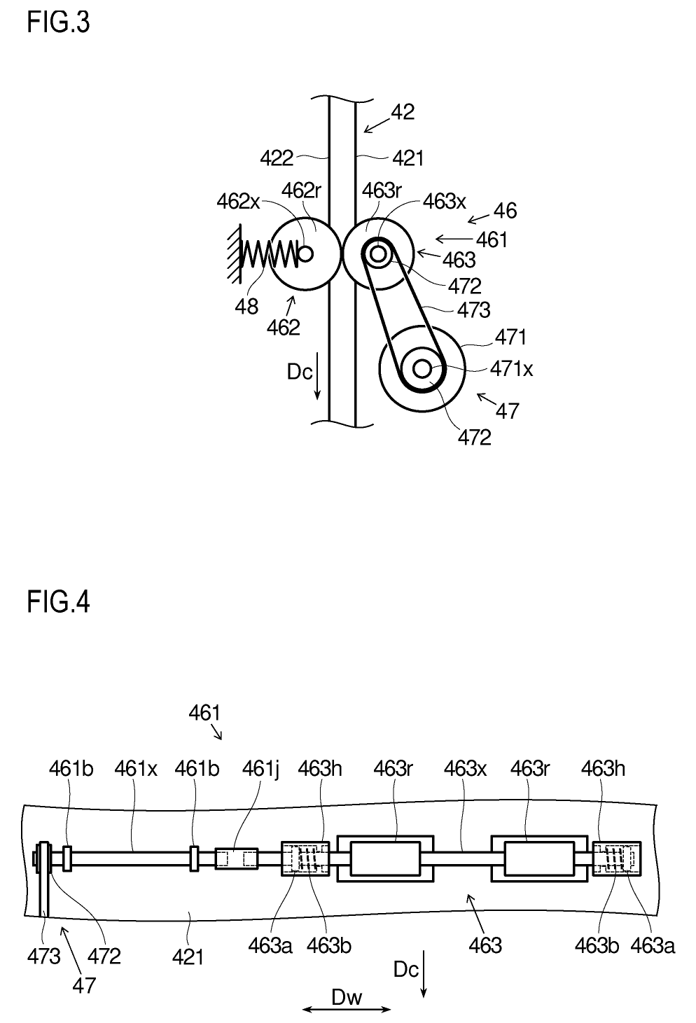

The configuration of the conveyance roller pair 46 in the reverse conveyance path 42 will then be described. FIG. 3 is a front view of an area around the conveyance roller pair 46 in the sheet conveyance device 4 shown in FIG. 2. The reverse conveyance path 42 includes a first conveyance guide member 421 and a second conveyance guide member 422 which are arranged opposite each other through the sheet conveyance path on the reverse conveyance path 42. Each of the first conveyance guide member 421 and the second conveyance guide member 422 is formed in the shape of a flat plate extending in the sheet conveyance direction Dc and the sheet width direction (depth direction in the plane of the sheet in FIG. 3) of the sheet S.

The conveyance roller pair 46 is arranged on the upstream side of the registration roller pair 44 in the sheet conveyance direction. The conveyance roller pair 46 forms a roller pair with a first roller 461 and a second roller 462. The first roller 461 and the second roller 462 are arranged opposite each other through the sheet conveyance path on the reverse conveyance path 42. The first roller 461 and the second roller 462 sandwich the sheet S therebetween to convey the sheet S.

The first roller 461 is rotatably supported to the first conveyance guide member 421. The first roller 461 is a drive roller which is rotated by receiving an input of a drive force from a drive motor 471 in a drive mechanism 47.

The drive mechanism 47 for the first roller 461 includes, for example, the drive motor 471, two pulleys 472 and a drive belt 473. The two pulleys 472 are fixed to the rotation shaft 471x of the drive motor 471 and the rotation shaft 461x of the first roller 461 respectively, and the drive belt 473 is wound around the pulleys 472.

The second roller 462 is rotatably supported to the second conveyance guide member 422. The second roller 462 is a driven roller which makes contact with the first roller 461, and thereby follows the first roller 461 to rotate. An opposite biasing member 48 is arranged in the location of the second roll shaft 462x of the second roller 462.

The opposite biasing member 48 is formed with, for example, a compression coil spring which is arranged to expand and contract in the radial direction of the second roller 462. In the opposite biasing member 48, one end portion in the direction of expansion and contraction is supported to the second conveyance guide member 422, and the other end portion is in contact with the circumferential surface of the second roll shaft 462x in the second roller 462. The opposite biasing member 48 biases the second roller 462 to the second conveyance guide member 422 in a direction in which the second roller 462 approaches the first roller 461, that is, in a rightward direction in FIG. 3.

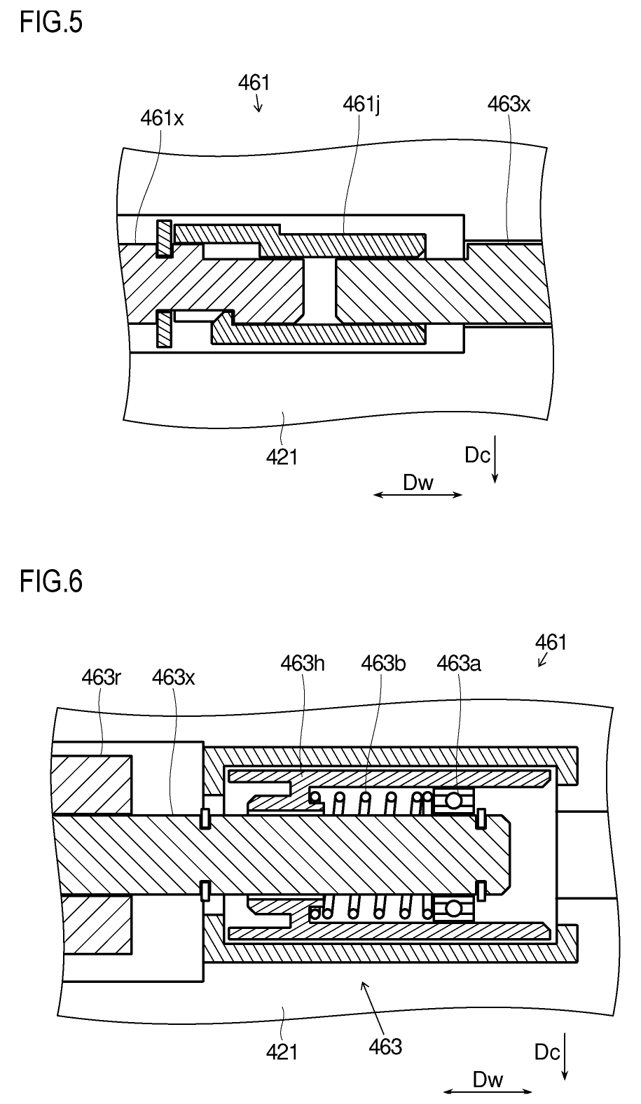

The configuration of the first roller 461 in the conveyance roller pair 46 will then be described in detail. FIG. 4 is a side view of the first roller 461 in the conveyance roller pair 46 shown in FIG. 3. FIG. 5 is a cross-sectional side view of a joint portion 461j of the first roller 461 shown in FIG. 4. FIG. 6 is a cross-sectional side view of an area around a bearing portion 463a for a first roll shaft 463x in the first roller 461 shown in FIG. 4. Although FIG. 6 shows the bearing portion 463a on one end side of the first roll shaft 463x in an axial direction, the bearing portion 463a on the other end side in the axial direction has the same configuration. In FIGS. 4 to 7, arrows indicating the sheet conveyance direction Dc and the sheet width direction Dw are shown.

The first roller 461 includes a drive shaft 461x, the joint portion 461j and a first conveyance unit 463.

As shown in FIG. 4, the drive shaft 461x is arranged on the outer side of the joint portion 461j and the first conveyance unit 463 in the sheet width direction Dw with respect to a center portion in the sheet width direction Dw. The drive shaft 461x extends in the sheet width direction Dw, and is rotatably supported to the first conveyance guide member 421 via the bearing portions 461b arranged in the vicinity of both end portions in the sheet width direction Dw (axial direction) respectively. In the axial direction of the drive shaft 461x, the pulley 472 of the drive mechanism 47 is fixed to one end portion, and the joint portion 461j is fixed to the other end portion. A rotational drive force is transmitted from the drive mechanism 47 via the pulley 472 to the drive shaft 461x.

As shown in FIGS. 4 and 5, the joint portion 461j is arranged between the drive shaft 461x and the first roll shaft 463x of the first conveyance unit 463 in the sheet width direction Dw. The joint portion 461j is formed substantially in the shape of a cylinder extending in the sheet width direction Dw. The drive shaft 461x and the first roll shaft 463x are inserted into the joint portion 461j from both end portions in the axial direction respectively. The joint portion 461j couples the drive shaft 461x to the first roll shaft 463x in the sheet width direction Dw. In the joint portion 461j, the drive shaft 461x and the first roll shaft 463x are spaced a predetermined distance.

The one end portion of the drive shaft 461x is fixed to the joint portion 461j. One end portion of the first roll shaft 463x is held by the joint portion 461j to be movable in the sheet width direction Dw. Specifically, in a part of the joint portion 461j into which the first roll shaft 463x is inserted, each of the inner circumferential portion of the joint portion 461j and the outer circumferential portion of the first roll shaft 463x has a D-shaped cross-sectional shape orthogonal to the axial direction, and is formed with a so-called D cut. In this way, the first roll shaft 463x is movable in the sheet width direction Dw relative to the joint portion 461j, and the rotational drive force around the shaft is transmitted from the joint portion 461j.

The first conveyance unit 463 is arranged in the center portion in the sheet width direction Dw. The first conveyance unit 463 includes the first roll shaft 463x, a pair of holders 463h, a pair of bearing portions 463a and a pair of first biasing members 463b.

As shown in FIG. 4, the first roll shaft 463x is arranged side by side with the drive shaft 461x via the joint portion 461j in the sheet width direction Dw. A first roll portion 463r which makes contact with the second roller 462 is fixed to the first roll shaft 463x. The first roll portion 463r has an outside diameter larger than the that of the first roll shaft 463x, and extends in the sheet width direction Dw. In the present embodiment, the first roller 461 includes two first roll portions 463r which are separate in the sheet width direction Dw.

As shown in FIG. 4, the pair of holders 463h are respectively arranged at both end portions of the first roll shaft 463x in the axial direction. The holder 463h arranged on the side of the joint portion 461j in the first roll shaft 463x is arranged on the inner side (the side of the first roll portion 463r) of the joint portion 461j in the sheet width direction Dw. The pair of holders 463h each are formed in the shape of a cylinder extending in the sheet width direction Dw, and are fixed to the first conveyance guide member 421. The pair of holders 463h each support, inside the cylinders, both end portions of the first roll shaft 463x in the axial direction via the pair of bearing portions 463a.

As shown in FIG. 6, the pair of bearing portions 463a are respectively arranged inside the pair of cylindrical holders 463h. The pair of bearing portions 463a rotatably support both end portions of the first roll shaft 463x in the axial direction (sheet width direction Dw), respectively. The bearing portion 463a is arranged inside the holder 463h in a state where the bearing portion 463a is movable relative to the holder 463h in the sheet width direction Dw. Specifically, the bearing portion 463a is movable in the sheet width direction Dw such that the outer circumferential surface of the bearing portion 463a slides on the inner circumferential surface of the holder 463h. In other words, the pair of bearing portions 463a are movable together with the first roll shaft 463x along the sheet width direction Dw.

As shown in FIG. 6, the pair of first biasing members 463b are arranged inside the pair of cylindrical holders 463h, respectively. The first biasing members 463b is formed with a compression coil spring which is arranged to expand and contract in the radial direction (sheet width direction Dw) of the first roll shaft 463x, and is arranged such that the first roll shaft 463x penetrates the interior of the coil portion thereof.

In the first biasing members 463b, one end portion (center side in the sheet width direction Dw) in the direction of expansion and contraction is in contact with the holder 463h, and the other end portion (outer side in the sheet width direction Dw) is in contact with the bearing portion 463a. The pair of first biasing members 463b respectively bias the pair of bearing portions 463a in opposite directions along the sheet width direction Dw. In other words, in the present embodiment, each of the pair of first biasing members 463b biases the first roll shaft 463x (first roll portion 463r) to move outer side in the sheet width direction Dw.

In the configuration described above, the first roll shaft 463x to which the first roll portion 463r that makes contact with the second roller 462 to convey the sheet S is fixed is movable in the sheet width direction Dw without obtaining the drive force from the drive mechanism. In other words, in a case where the sheet S is moved in the sheet width direction Dw when the registration roller pair 44 corrects a displacement in the position, it is possible to move the first roll shaft 463x in the sheet width direction Dw to follow the movement without preventing the movement of the sheet S. Hence, the sheet conveyance device 4 can appropriately correct a displacement in the position of the sheet S in the sheet width direction with a simple configuration in which an increase in the number of drive mechanisms including drive sources is suppressed.

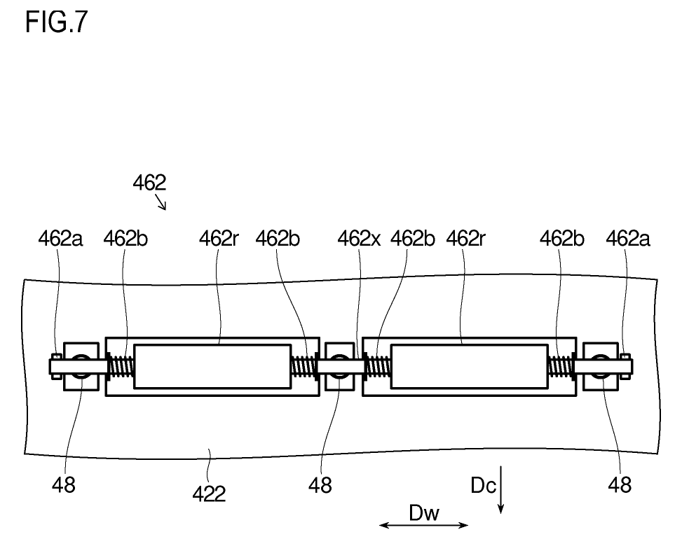

The configuration of the second roller 462 in the conveyance roller pair 46 will then be described in detail. FIG. 7 is a side view of the second roller 462 in the conveyance roller pair 46 shown in FIG. 3.

The second roller 462 is arranged in the center portion in the sheet width direction Dw. The second roller 462 includes the second roll shaft 462x, a second roll portion 462r and a pair of second biasing members 462b.

The second roll shaft 462x extends in the sheet width direction Dw. The second roll shaft 462x is rotatably supported to the second conveyance guide member 422 via bearing portions 462a arranged in the vicinity of both end portions in the sheet width direction Dw (axial direction). As described previously, in the location of the second roll shaft 462x, the opposite biasing member 48 is arranged. The opposite biasing member 48 biases the second roller 462 to the second conveyance guide member 422 in the direction in which the second roller 462 approaches the first roller 461 (see FIG. 3).

The second roll portion 462r is rotatably supported to the second roll shaft 462x, and makes contact with the first roll portion 463r. The second roll portion 462r has an outside diameter larger than that of the second roll shaft 462x, and extends in the sheet width direction Dw. In the present embodiment, the second roller 462 includes two second roll portions 462r which are separate in the sheet width direction Dw.

The pair of second biasing members 462b is formed with a compression coil spring which is arranged to expand and contract in the radial direction (sheet width direction Dw) of the second roll shaft 462x, and is arranged such that the second roll shaft 462x penetrates the interior of the coil portion thereof. Each of the pair of second biasing members 462b is arranged on the outer sides of both end portions of the second roll portion 462r in the axial direction (sheet width direction Dw). In other words, in the present embodiment, the second roller 462 includes two pairs of second biasing members 462b which are respectively arranged for the two second roll portions 462r that are separate in the sheet width direction Dw.

In the second biasing member 462b, one end portion in the direction of expansion and contraction is in contact with the second conveyance guide member 422, and the other end portion is in contact with the second roll portion 462r. The pair of second biasing members 462b bias the second roll portion 462r in opposite directions along the sheet width direction Dw. In other words, in the present embodiment, the pair of second biasing members 462b bias the second roll portion 462r to individually press the second roll portion 462r such that the second roll portion 462r is moved in the sheet width direction Dw.

In the configuration described above, as with the first roll portion 463r, the second roll portion 462r which makes contact with the first roll portion 463r to convey the sheet S is movable in the sheet width direction Dw without obtaining the drive force from the drive mechanism. In other words, in a case where the sheet S is moved in the sheet width direction Dw when the registration roller pair 44 corrects a displacement in the position, it is possible to enhance the effect of preventing the movement of the sheet S. Hence, the sheet conveyance device 4 can more effectively correct a displacement in the position of the sheet S in the sheet width direction.

As described above, the first roller 461 includes a plurality of (for example, two) first roll portions 463r which are fixed to the first roll shaft 463x. The second roller 462 includes a plurality of (for example, two) second roll portions 462r and a plurality of (for example, two) pairs of second biasing members 462b. The two second roll portions 462r individually make contact with the two first roll portions 463r, respectively. The two pairs of second biasing members 462b individually bias the two second roll portions 462r in opposite directions along the sheet width direction Dw, respectively.

In the configuration described above, the two second roll portions 462r are moved in the sheet width direction Dw independently of each other. In this way, it is possible to flexibly prevent the movement of the sheet S exhibiting an unexpected behavior in the sheet width direction Dw. Consequently, the sheet conveyance device 4 can more effectively correct a displacement in the position of the sheet S in the sheet width direction.

Although the embodiment of the present disclosure has been described above, the scope of the present disclosure is not limited to the embodiment.

For example, although in the embodiment described above, the configuration of the present disclosure described with reference to FIGS. 3 to 7 is applied to the conveyance roller pair 46 in the reverse conveyance path 42, the present disclosure is not limited to this configuration. As long as the conveyance roller pair on the upstream side of the registration roller pair 44 in the sheet conveyance direction is provided, the configuration of the present disclosure may be applied to, for example, the conveyance roller pairs 45 in the sheet conveyance path 41.

Although in the embodiment described above, the image forming apparatus 1 is the image forming apparatus of the so-called tandem system for color printing which sequentially superimposes images of a plurality of colors to form an image, the present disclosure is not limited to this type of image forming apparatus. The image forming apparatus may be an image forming apparatus for color printing other than the tandem system or an image forming apparatus for monochrome printing.

What is claimed is:

1. A sheet conveyance device comprising:
a registration roller pair that
extends in a sheet width direction orthogonal to a sheet conveyance direction, and
corrects a displacement in a position of a sheet in the sheet width direction, the sheet being conveyed; and
a conveyance roller pair including a first roller and a second roller that
are arranged on an upstream side of the registration roller pair in the sheet conveyance direction and
are rotatably arranged opposite each other to convey the sheet,
wherein the first roller includes:
a drive shaft which extends in the sheet width direction, and to which a rotational drive force is transmitted;
a first conveyance unit including a first roll shaft which is arranged side by side with the drive shaft in the sheet width direction, and to which a first roll portion that makes contact with the second roller is fixed; and
a joint portion that couples the drive shaft to the first roll shaft in the sheet width direction, and holds the first roll shaft such that the first roll shaft is movable in the sheet width direction, and
the first conveyance unit includes:
a pair of bearing portions that rotatably support both end portions of the first roll shaft in the sheet width direction, and are movable along the sheet width direction together with the first roll shaft; and
a pair of first biasing members that respectively bias the pair of bearing portions in opposite directions along the sheet width direction.

2. The sheet conveyance device according to claim 1,
wherein the second roller includes:
a second roll shaft that extends in the sheet width direction;
a second roll portion that is rotatably supported to the second roll shaft, and makes contact with the first roll portion; and
a pair of second biasing members that bias the second roll portion in the opposite directions along the sheet width direction.

3. The sheet conveyance device according to claim 2,
wherein the first roller includes a plurality of first roll portions each being the first roll portion that are fixed to the first roll shaft, and
the second roller includes:
a plurality of second roll portions each being the second roll portion that individually make contact with the plurality of first roll portions, respectively; and
a plurality of pairs of second biasing members each pair of second biasing members being the pair of second biasing members that individually bias the plurality of second roll portions in the opposite directions along the sheet width direction, respectively.

4. An image forming apparatus comprising:
the sheet conveyance device according to claim 1.
